(19) United States
(12) Patent Application Publication
(10) Pub. No.: US 2004/0006874 A1
(43) Pub. Date: Jan. 15, 2004

(54) Travel feeding utensil

(75) Inventors: Mike Kamm, Chardon, OH (US); Scott R. Thomason, Maple Height, OH (US); Nicholas J. Mastandrea, Newbury, OH (US)

Correspondence Address: Timothy D. Smith, Brouse McDowell, LPA, 500 First National Tower, 106 S. Main Street, Akron, OH, 44308-1471, US

(73) Assignee: Great Lakes Engineering & Design, Inc.

(21) Appl. No.: 10/606,091

(22) Filed: Jun. 25, 2003

Related U.S. Application Data
(60) Provisional application No. 60/394,677, filed on Jul. 9, 2002.

(51) Int. Cl. A47J 43/28

(52) U.S. Cl. 30/141; 30/324

(57) ABSTRACT

An eating utensil includes a food storage section and a food holding section. The holding section also includes a selectively engage-able valve that dispenses food contained in the food storage section. The two sections are separable from each other.

This application claims priority from U.S. provisional application No. 60/394,677, filed Jul. 9, 2002.

### 1. BACKGROUND OF THE INVENTION

A. Field of Invention

This invention pertains to the art of methods and apparatuses of feeding utensils and more specifically to a feeding utensil that can selectively dispense food through a food passage valve.

B. Description of the Related Art

When using a utensil for feeding in a mobile environment, small children, elders & physically impaired adults often have difficulty maintaining clean surroundings due to food spillage from bowls, jars, or any other food holding container. The present invention describes a unique feeding device that allows food to be dispensed on an as needed basis directly to an affixed utensil head attached to the end of a variable volume container greatly reducing the chances for spillage and to facilitate ease of feeding.

### II. SUMMARY OF THE INVENTION

The invention describes a utensil attached by means of screwing or snapping to a variable volume container. The container reduces in volume when pressure is applied. Food is forced through a pressure sensitive valve from inside the container and on to the attachable utensil allowing feeding to occur.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a feeder showing a food storage portion and a food holding portion.

FIG. 2 is a perspective view of a feeder showing a food storage portion and a food holding portion.

FIG. 3 is a perspective view of the base without any molded material.

FIG. 4 is a perspective view of the base with molded material.

FIG. 5 is a perspective view of the food storage portion.

FIG. 6 is a cross-sectional view of the feeder.

FIG. 7 is a perspective view of an alternate embodiment of a feeder.

### IV. DESCRIPTION OF THE PREFERRED EMBODIMENT

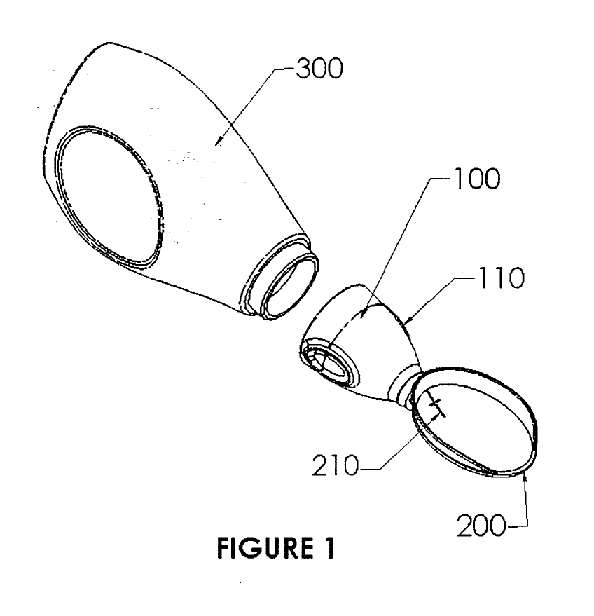

Referring now to the drawings wherein the showings are for purposes of illustrating a preferred embodiment of the invention only and not for purposes of limiting the same, FIG. 1 shows a feeder or hand held eating utensil depicted generally at 100. The feeder 100 may include a base 110 that is a conventional utensil design, which may be a spoon. Over-molded on the feeder base 110 may be a flexible covering 200 that includes a pressure sensitive valve 210 or food passage valve. The pressure sensitive valve 210 functions to meter the correct amount of food onto the utensil 100 from a variable volume container 300 when pressure is applied.

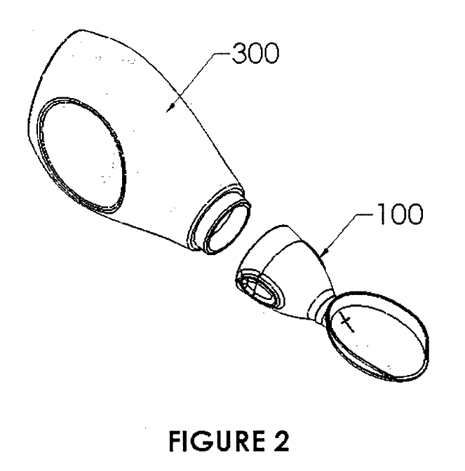

With reference to FIGS. 1 and 2, a variable volume container 300 or food storage section is shown separate from the attachable utensil 100 or food holding section. In one embodiment, the variable volume container 300 is selectively attachable/detachable from the utensil 100. The variable volume container 300 may be constructed from a resiliently deformable material, which may be a plastic material. However, any material may used to construct variable volume container 300 that is chosen with sound engineering judgment. The variable volumes container 300 may include an opening 303 that interfaces with the base 110 to communicate food when the container 300 is pressurized. It is noted that the container may be pressurized when an operator squeezes the variable volume container 300. However, any manner of communicating food from the container 100 to the base 110 may be chosen with sound engineering judgment. The opening 303 may comprise a resiliently deformable ridge 306 that snaps into engagement with the base 110. In this manner, the container 300 may be selectively detached filled and/or refilled with food and reconnected to the base 110 for continued use. It is noted that when the food storage section contains food and when the food storage section and the food holding section are connected, the food is substantially enclosed or contained with the feeder or utensil.

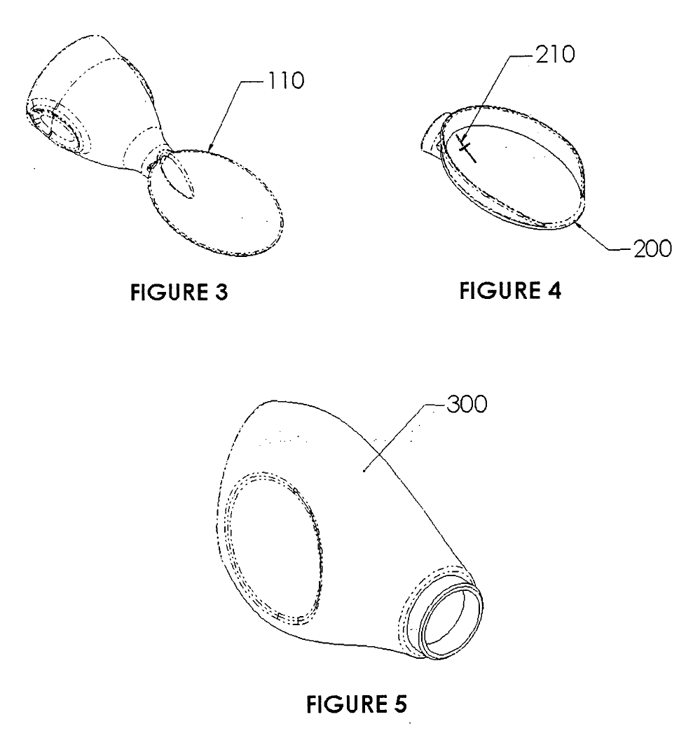

With reference to FIGS. 3 and 4, the feeder base 110 is shown without the over-molded flexible covering 200 and pressure sensitive valve 210. Base 110 may be made of injection molded plastic, stainless steel or any other suitable material as will occur to those skilled in the art. The over-molded flexible covering 200 and pressure sensitive valve 210 may be molded onto base 110. Flexible covering 200 and pressure sensitive valve may be made of silicone or any other suitable flexible material as will occur to those skilled in the art. In one embodiment, the valve 210 may be constructed from fashioning slits in the flexible material. When pressure is supplied via the container 300 food is squeezed through slits forming the valve 210. It should be noted that the interface between the container 300 and base 110 may form a food tight seal when attached or engaged. In this manner, when the feeder 100 is filled and ready for use, food may be ejected through the valve 210.

FIG. 5 shows the variable volume container 300 that may be injection molded polymer or any other suitable material as will occur to those skilled in the art.

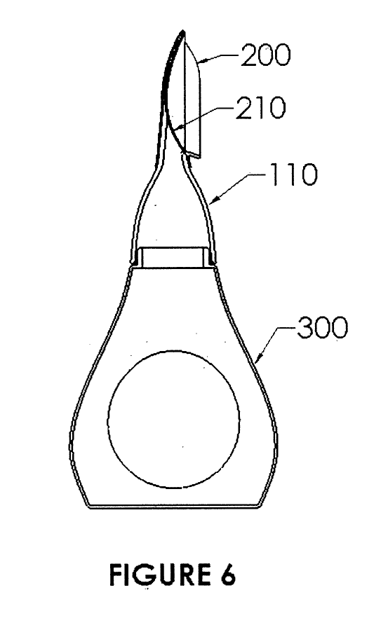

FIG. 6 shows a cross-sectional drawing of the spoon in a free standing position with base 110 and over-molded covering 200 and pressure sensitive valve 210, including variable volume container 300.

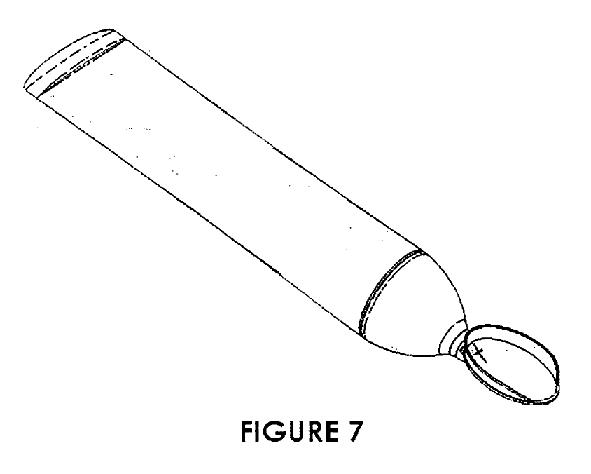

FIG. 7 shows an alternate design of the variable volume container. In this embodiment, the utensil's food storage section may be pre-packaged with predetermined types and/or quantities of associated food. Additionally, the food storage section may be fixedly attached with respect to the food holding section. In this embodiment, the utensil may not be refillable or reuse-able. The food storage section may be constructed from a collapse-able material.

The spoon described herein may be made such that it is either disposable or re-useable. The flexible over-molding 200 and pressure sensitive valve 210 may be made of a material such as silicone that is safely and easily washable by hand or in a conventional dishwasher. The variable volume container 300 may be made such that is either disposable or re-useable. The container can also be packaged and sealed with food contained inside. This will aid in the ease of use and limit any spilling that can occur when trying to transfer the food from its original container into this variable volume container.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. A hand-held eating utensil, comprising:
a food holding section;
a food storage section selectively operatively communicated to the food holding section; and,
wherein associated food is substantially completely enclosed within the eating utensil.

2. The utensil of claim 1, wherein the food holding section is a spoon.

3. The utensil of claim 1, further comprising:
a food passage valve adapted to selectively operatively communicate associated food from the food storage section to the food holding section.

4. The utensil of claim 3, wherein the food storage section is selectively refillable with associated food.

5. The utensil of claim 3, wherein the food storage section is selectively connected to the food storage section.

6. The utensil of claim 5, wherein the food storage section is made from a resiliently deformable material.

7. The utensil of claim 6, wherein the food storage section is made from plastic.

8. The utensil of claim 3, wherein the food passage valve comprises slits fashioned in the food holding section.
